(19) United States
(12) Patent Application Publication
(10) Pub. No.: US 2006/0102577 A1
(43) Pub. Date: May 18, 2006

(54) Swivelling hoist with high load capability

(75) Inventor: Jan Vestenik, Winnipeg (CA)

Correspondence Address: ADE & COMPANY INC., P.O. BOX 28006 1795 HENDERSON HIGHWAY, WINNIPEG, MB, R2G1P0, CA

(73) Assignee: Unique Concepts Ltd.

(21) Appl. No.: 10/958,482

(22) Filed: Oct. 6, 2004

(51) Int. Cl. B66C 23/18

(52) U.S. Cl. 212/253

(57) ABSTRACT

A portable hoist primarily for mounting on the ground at a manhole or similar location for lifting a load such as a person entering the manhole includes a base with a generally Y-shape defining a rear leg and two diverging front legs for mounting on the ground with the front legs either side of the hole. A jib portion is mounted on a vertical post portion of the base and extends upwardly and forwardly therefrom to a cable guide at an upper end overlying the hole. The jib portion is formed by a tubular body extending substantially from the bottom end at the base to the upper end which is smoothly curved with a constant radius of curvature. The body is formed in two parts with one siding inside the other and of the same curvature. Each part has a straight end portion where it attaches to the base and the cable guide respectively. A winch mounting for a winch for the cable is attached to the lower portion at its upper end. The front legs are also formed similarly as two inter-fitting curved parts. A transport bracket for the hitch of a vehicle is provided for mounting the base and the jib portion when separated, with the jib portion standing on a post and the base hanging from a receptacle with the front legs depending in a plane parallel to the jib portion. The curved jib and legs can be manufactured simply and cheaply from limited parts in aluminum with limited welding.

This application claims priority under 35 U.S.C.119 from Provisional Application 60/506,155 filed Sep. 29^{th} 2003.

The present invention relates a swivelling hoist which includes a hoist arm extending to one side of a mast where the mast can swivel around a vertical axis longitudinal of the mast with low rotational forces being required to effect the swivelling action while the arm can support relatively high loads.

It is an object of the present invention to provide an improved hoist which includes a hoist arm extending to one side of a mast where the mast can swivel around a vertical axis longitudinal of the mast with low rotational forces being required to effect the swivelling action while the arm can support relatively high loads.

According to a first aspect of the invention there is provided a hoist for mounting on a support surface for lifting a load in a direction generally at right angles to the support surface, the hoist comprising:

a base member for mounting on the support surface, the base member including a vertical post;

a jib member for mounting on the base member including a mast portion for mounting on the post and an arm connected to the mast portion and extending outwardly to one side thereof;

the post having a circular cylindrical outer surface;

the mast portion defining a sleeve surrounding the post and having a circular cylindrical bushing at a lower end thereof for engaging the outer surface of the post as a sliding fit thereon allowing rotation of the mast portion relative to the post about a vertical longitudinal axis of the post;

and a two part ball and socket coupling between the mast portion and the post allowing rotation of the mast portion around the longitudinal axis of the post, the coupling having one part located inside the mast portion and the coupling having the other part located at or adjacent the upper end of the post;

the coupling being arranged such that that the mast portion can slide longitudinally outside the post into an assembled position in which the ball and socket coupling is connected with the one part sitting on the other part;

and the mast portion and the post being arranged such that, in the assembled condition the bushing is spaced axially from the ball and socket coupling to allow side loads from the arm to be communicated from the mast portion through the coupling and the bushing to the post while allowing ready rotation of the mast portion around the post.

Preferably the ball is on the post and the socket is on the mast.

Preferably the one part is within an upper end of the mast portion.

Preferably the other part is within the post spaced from top of the post.

Preferably the post includes a collar surrounding the other part.

Preferably the collar has holes to locate angular orientation of the mast portion on the post.

Preferably the mast portion has the bushing substantially at the bottom and at the bottom of the post.

Preferably the mast portion forms a circular cylindrical sleeve.

Preferably the arm is pivoted to the top of mast portion so as to be raisable relative thereto.

Preferably the arm is operable by a cylinder.

### BRIEF DESCRIPTION OF THE DRAWINGS

On embodiment of the invention will now be described in conjunction with the accompanying drawings in which:

FIG. 1 is side elevational view of an assembled hoist according to the present invention.

FIGS. 2 and 3 are side elevational views of the mast portion only of the hoist of FIG. 1.

FIG. 4 is a side elevational view of the base member only of the hoist of FIG. 1.

FIG. 5 is a cross sectional view of the mast portion and post of FIG. 2 to 4 in assembled condition.

### DETAILED DESCRIPTION

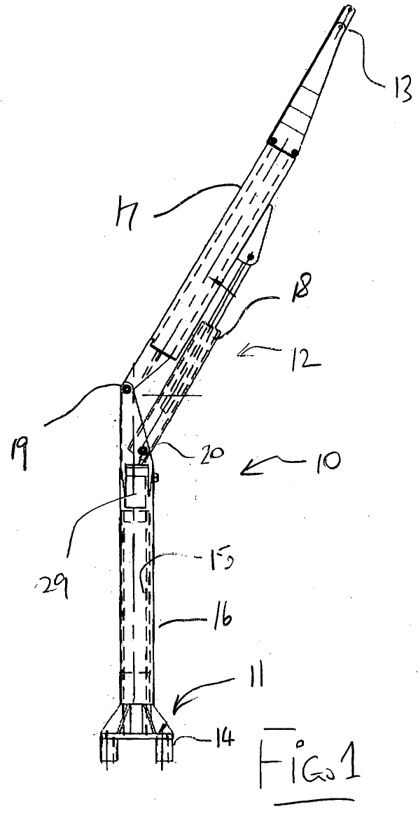

In FIG. 1 is shown a hoist 10 having a base portion 11 for mounting upon a suitable support surface and a jib member 12 which provides a raised support point 13 which can be raised and lowered for raising and lowering an object as required.

The base member 11 comprises a mounting base 14 and a post 15 which stands vertically upwardly and defines a cylindrical outer surface for receiving a sleeve 16 of the jib portion. The sleeve 16 defines a mast which stands vertically upwardly on the post to a raised upper end which supports an arm 17 carrying the upper point 13 and a cylinder 18 for actuating movement of the arm 17. The arm 17 thus mounts on an upper pivot 19 of the mast defining a transverse axis. The cylinder 18 has a lower end pivot 20 also carried on the mast at a position spaced from the axis 19 so that expansion and contraction of the cylinder causes the arm to move upwardly and downwardly from a raised substantially vertical position to a lower substantially horizontal position.

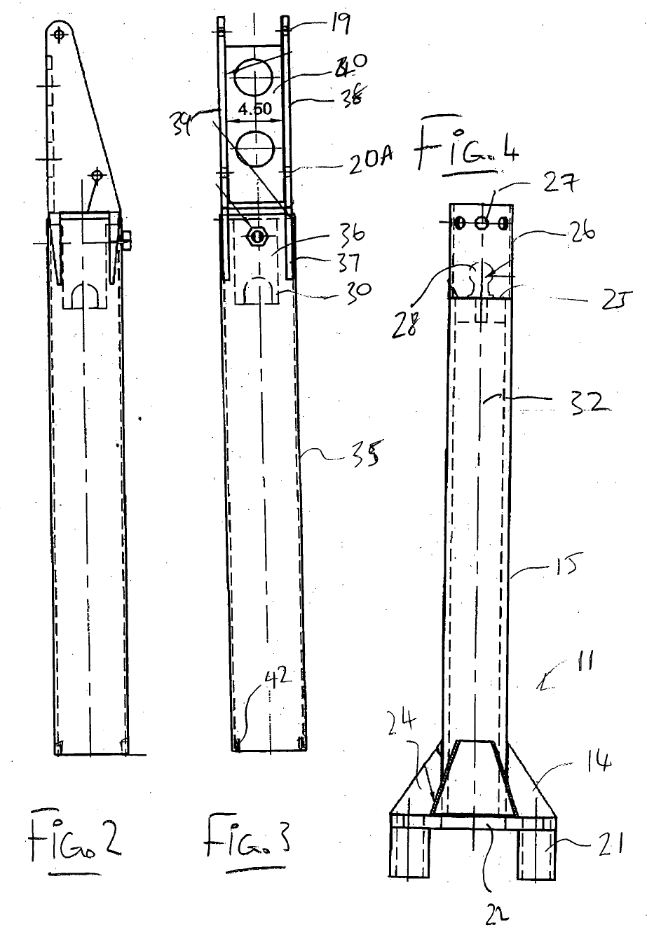

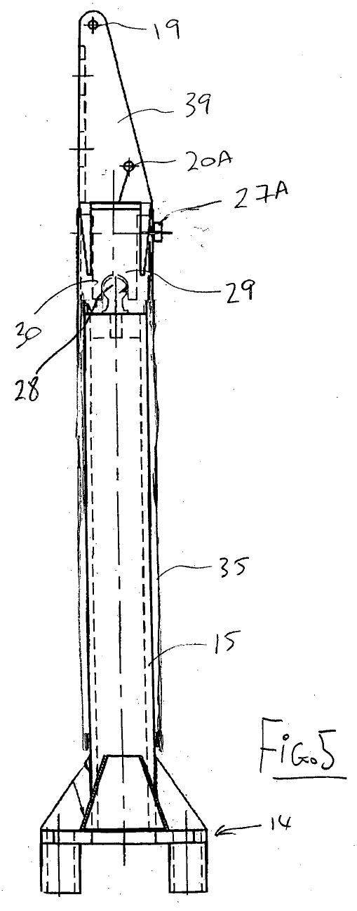

As shown in FIG. 4, the base member 11 includes a bottom base 14 with 4 spaced posts 21 attached to a base plate 22 so that pins extending through the posts 21 clamp the base plate to the floor. The post 15 stands upwardly from the base plate 22 and is reinforced by a plurality of angularly spaced gussets 24. The post forms a hollow tube with a cylindrical peripheral wall and a top transverse plate 25 welded across the upper end of the tube 15. A collar 26 is attached on top of the plate 25 and stands upwardly therefrom having a diameter matching that of the post and forming an upper surrounding protecting portion. Angularly spaced holes 27 are provided in the collar around the top edge. On the plate 25 is mounted a ball 28 of a ball and socket coupling 29 shown in FIG. 1. The ball and socket coupling comprises the ball 28 and a receptacle or socket 30 provided on the mast portion shown in FIGS. 2 and 3.

Thus the ball 28 defines a vertical axis of rotational movement longitudinally of the post as indicated at 32. The mast portion shown in FIGS. 2 and 3 comprises a sleeve 35 having a diameter slightly greater than that of the post 15 so that it is sufficiently large to surround the post with a space therebetween. The socket 30 is mounted within the post on a receptacle 36 attached within the post and held fixed in place by a mounting sleeve 37. The receptacle 36 thus holds the socket 30 in fixed position inside the sleeve 35 so that the ball and socket can interconnect as the mast is slid downwardly over the post. At the top of the sleeve 35 forming the mat is provided a pair of parallel side plates 38 and 39 which extend upwardly from the sleeve and define spaced supports for the pivot 19 and for a mounting 20A of the lower end of the cylinder. The plates are braced by suitable interconnections 40. At the bottom of the sleeve 35 is provided a cylindrical bushing 42 which is located inside the bottom edge of the sleeve and has an inside surface matching the diameter of the outside surface of the post so that it is a sliding fit on the post.

The mast defined by the sleeve 35 can therefore be inserted readily into place onto the post simply by inserting the upper end of the post defined by the collar 26 into the lower end of the sleeve 35 and sliding the sleeve 35 downwardly until the socket 30 engages onto the ball 28.

In this position the mast is held in place on the vertical swivel axis 32 and the bearings providing by the ball and socket at the upper end and the bushing at the lower end are spaced by substantially the full length of the sleeve 35 thus allowing significant side loads on the upper end 13 without providing a high level of friction sufficient to resist rotation of the mast around the post. The low friction provided by the ball and the socket and provided by the bushing allow the mast to be readily rotated even when carrying relatively high loads due to the wide spacing of the bearings and due to the use of the ball and socket bearing and the bushing at the lower end.

It will of course be appreciated that the ball and socket can be inverted so that the ball is carried on the mast and the socket on the post. It is also possible to reverse the arrangement of the mast and post in that the post can be located outside the mast but this is not preferred. The angular position of the mast relative to the post can be adjusted by inserting a pin 27A into a respective one of the holes 27 which is aligned with a selected hole across the upper end of the sleeve 35 above the socket 30.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A hoist for mounting on a support surface for lifting a load in a direction generally at right angles to the support surface, the hoist comprising:
a base member for mounting on the support surface, the base member including a vertical post;
a jib member for mounting on the base member including a mast portion for mounting on the post and an arm connected to the mast portion and extending outwardly to one side thereof;
the post having a circular cylindrical outer surface;
the mast portion defining a sleeve surrounding the post and having a circular cylindrical bushing at a lower end thereof for engaging the outer surface of the post as a sliding fit thereon allowing rotation of the mast portion relative to the post about a vertical longitudinal axis of the post;
and a two part ball and socket coupling between the mast portion and the post allowing rotation of the mast portion around the longitudinal axis of the post, the coupling having one part located inside the mast portion and the coupling having the other part located at or adjacent the upper end of the post;
the coupling being arranged such that that the mast portion can slide longitudinally outside the post into an assembled position in which the ball and socket coupling is connected with the one part sitting on the other part;
and the mast portion and the post being arranged such that, in the assembled condition the bushing is spaced axially from the ball and socket coupling to allow side loads from the arm to be communicated from the mast portion through the coupling and the bushing to the post while allowing ready rotation of the mast portion around the post.

2. The hoist according to claim 1 wherein the ball is on the post and the socket is on the mast.

3. The hoist according to claim 1 wherein the one part is within an upper end of the mast portion.

4. The hoist according to claim 1 wherein the other part is within the post spaced from top of the post.

5. The hoist according to claim 4 wherein the post includes a collar surrounding the other part.

6. The hoist according to claim 5 wherein the collar has holes to locate angular orientation of the mast portion on the post.

7. The hoist according to claim 1 wherein the mast portion has the bushing substantially at the bottom and at the bottom of the post.

8. The hoist according to claim 1 wherein the mast portion forms a circular cylindrical sleeve.

9. The hoist according to claim 1 wherein the arm is pivoted to the top of mast portion so as to be raisable relative thereto.

10. The hoist according to claim 1 wherein the arm is operable by a cylinder.
